(19) United States
(12) Patent Application Publication
(10) Pub. No.: US 2025/0305628 A1
(43) Pub. Date: Oct. 2, 2025

(54) Moveable Mounting Bracket Assembly

(71) Applicant: Bruce G. Phillips, Boca Raton, FL (US)

(72) Inventor: Bruce G. Phillips, Boca Raton, FL (US)

(21) Appl. No.: 19/091,080

(22) Filed: Mar. 26, 2025

Related U.S. Application Data
(60) Provisional application No. 63/571,302, filed on Mar. 28, 2024.

(51) Int. Cl. F16M 13/02; H02G 3/12

(52) U.S. Cl. CPC F16M 13/022; H02G 3/12

(57) ABSTRACT

A Moveable Mounting Bracket Assembly (MMBA) comprising a single or double box MMBA includes a Direct Stud Mechanism (DSM) attached to a wall stud by screws. The DSM includes a wall stud flange, a Movable Mounting Plate (MMP) flange, two MMP rails, and an adjusting screw flange. The MMP slides in and out on the MMP rails and is held in position by the depth adjusting screw which threadedly engages the MMP. A Handy Box Extension (HBE) is attached to the front of the MMP and a junction box is attached to the back of the MMP.

### CROSS-REFERENCE TO RELATED APPLICATIONS

This application claims priority from U.S. Provisional Patent Application No. 63/571,302, filed Mar. 28, 2024, which is hereby incorporated by reference.

### BACKGROUND OF THE INVENTION

The present invention relates to electrical junction box mounting brackets, and in particular to adjustable depth mounting brackets.

Manufacturers of electrical components in the U.S. and abroad produce junction boxes that are used to install electrical systems in buildings of all construction types, including residential, commercial, and industrial. These junction boxes are typically standard sizes, the most common being 2″×3″ (new work boxes), 4-inches square, and 4 11/16-inches square and so-called multi-gang (2-Gang-8+ Gang) with varying overall depths depending on the quantity of conductors (wires) being installed in the junction box and the allowable space in a framing (stud) cavity.

A typical installation in a framed wall may include a “new work box” or an assembly of components comprised of a 1) junction box, 2) a mounting bracket, and 3) a plaster ring.

A new work box may be mounted directly to a stud, with or without a bracket attached. A new work box does not require a plaster ring, and a plaster ring may not be attached to it. A bracket, if used with a new work box, is always an integral aspect of the new work box. The bracket (a metal strap of some kind) is typically welded to the new work box or formed with the new work box during the fabrication process.

Other junction box types: 4-inches square junction boxes; 4 11/16-inches square junction boxes; and so-called multi-gang (2-Gang-8+ Gang) junction boxes, may be attached directly to a stud without the use of a bracket by utilizing two holes intended for the purpose (and required by UL Standards) on its side. Fasteners are applied from the inside of these junction boxes, through the mounting holes, and into the studs. This mounting method may only be used before the plaster ring is attached to the face of the junction box. Once mounted in this fashion, the box position is fixed.

Another method of mounting 4-inches square junction boxes, 4 11/16-inches square junction boxes, and so-called multi-gang (2-Gang-8+ Gang) junction boxes directly to a stud, with a plaster ring attached, is to employ the use of a mounting bracket. The mounting bracket may be an integral component of the junction box itself. The bracket (a metal strap of some kind) is typically welded or swaged to the new work box or formed with the box during the fabrication process.

For junction boxes without integral mounting brackets, It is common in the industry to attach these junction boxes to a stud with the use of a separate bracket component. There are two methods to achieve this. Method #1 includes mounting the box directly to the bracket or an accessory component (e.g., a movable part that is attached to both the junction box and the bracket) that is an aspect of the bracket. Method #2 includes sandwiching the bracket between the junction box and a plaster ring.

For method #1, the bracket is attached to the stud(s) and then the box is attached directly to the bracket or an accessory component. Assembly is achieved by inserting fasteners through holes in the box and then into the bracket. Alternatively, sometimes the accessory component is mounted on/in one or more of the junction box's included knock-out holes. Most of these brackets cannot be attached to the junction box if a plaster ring is first attached, and none of these brackets can be used if a plaster ring and wiring devices (receptacles, switches, etc.) are first attached.

Method #2 requires that an assembly be made of at least three different components: the junction box, a mounting bracket, and a plaster ring. Typically, the mounting bracket is attached to the open front of the junction box. Junction box screws (shipped with the junction box) are then inserted through two corresponding holes in the mounting bracket and then a plaster ring is attached on top of the mounting bracket. The junction box screws are tightened, and the assembly of the components is complete and ready for mounting to a stud(s). These components can be assembled on or off the stud, or in place, but the resulting assembly is the same. Once this assembly is attached to the stud(s) the junction box cannot be moved in or out of the stud cavity (in some designs, the junction box may be repositioned left, right, up, or down, by sliding the junction box to a required position).

Often drywall or another substrate, e.g., wood, etc. is attached to the face of framed walls to provide a finished wall which seals the framed wall and its internal utilities, e.g., electrical wires, plumbing pipes, HVAC ductwork, insulation, etc. Often wallpaper, paint, tile or other finishes are applied to the drywall. A plaster ring is attached to the face of the junction box (but not to new work boxes). The plaster ring includes a protruding flange which provides a finished opening in the drywall and access to the interior of the junction box to which it is attached. The National Electrical Code (NEC) requires that the face of the plaster ring flange (or the front edge of a new work box) be within ⅛″ from the top/front surface of the finished wall. This NEC requirement is critical to ensure the proper installation and functioning of wiring devices, light fixtures, etc. that are attached to the plaster ring or new work box.

Electrical product manufacturers produce a variety of plaster rings, for every box type and size, that have various overall depths, e.g., ¼″, ½″, ⅝″, 1¼″, etc. These fixed depths correspond to the overall thickness of all material that is applied to the face of the stud including drywall, wood, tile, cabinets and other finish materials. Often, the final thickness of the drywall and finish materials may not be known during the construction process and/or designs may change during the construction process that make it difficult to know in advance what plaster ring size to use. In this instance, the installer may attach an Adjustable Plaster Ring (APR) which allows the installer to adjust the depth (in or out) after the drywall and wall finishes are installed.

However, APRs are problematic. APRs comprise two main components: 1) An outer plaster ring that attaches directly to a junction box, and 2) an inner sleeve which moves in and out in response to the installer turning one or more adjusting screws. In its lowest (height) position, the inner sleeve protrudes into the junction box. This inwardly protruding sleeve is problematic. For example, in shallow junction box designs the sleeve “blocks” knock-out holes on the sides of the junction box that are meant to have cable connectors installed in them. Even when a cable connector can be installed, the inwardly protruding sleeve can cut or otherwise damage the insulation on conductors (wires) posing at worst a fire hazard and at least a tripping circuit breaker. As a result of these problems, APRs are typically only used on junction boxes that have a trade depth of 2⅛″ or more—a more expensive option than commonly used 1½″ deep versions.

Manufacturers of electrical components also offer an “adjustable new work box.” These move in and out of the wall without the need for a plaster ring. A new work box does not require a plaster ring as it includes two formed downwardly facing ears, with threaded holes facing outward, for the attachment of wiring device(s). These adjustable new work boxes typically include a bracket to facilitate the attachment of the box directly to a framing member (stud), as described above.

Adjustable new work boxes have a dimension of 2″ wide×3″ high for a single-gang version and may have “gangs” added on to the box to accommodate additional devices. So, if two devices are required, then the installer will remove a side plate of an adjustable new work box and then add on another adjustable new work box (with one side removed) thereby creating a 2-gang adjustable switch box. Added boxes can be attached for 3-gang, 4-gang, etc. For every added gang, the box size increases approximately 2″ wide×3″ high. However, it is important to recognize that an adjustable new work box configured for more than 2-gang does not operate well when adjusting is required (the extended assembly of boxes cantilever to one side and only one side of the box adjusts). However, adjustable new work boxes have very limited field applications due to their small internal (area) volume. Recognized in the industry as “box fill”, the NEC sets limits for box fill (the number of wires in each box of a specific size/gauge).

The most common new work box size, that being 2½″ deep, may only contain five (5) #12 AWG wires and this does not include the mandatory deduction for the wiring device (counts as 2 wires), the grounding wire (counts as 1 wire) or the cable clamp. Therefore, a 2½″ deep new work box may only have one (1) 12-2 cable (NM-B or MC type) attached. A 3½″ deep new work box will allow two 12-2 cables to be attached (up to four total wires after deducting for the wiring device, ground wire and cable clamp). The fill limitations for new work boxes are problematic for most commercial applications and as such their use is generally limited to where no other option exists. New work boxes are used liberally in residential applications where cables are “daisy-chained” (one cable in, and one cable out) and because residential applications may use smaller wires (minimum #14 AWG) so one (1) more wire may be used in the new work boxes than if #12 is used. New work boxes are rarely used in commercial applications, e.g., high-rise construction, hospitals/healthcare, retail, office buildings, etc.

### SUMMARY OF THE INVENTION

The present invention addresses the above and other needs by providing an adjustable depth Moveable Mounting Bracket Assembly (MMBA), with an attachable or integrally formed device mounting flange that together form a new work box for mounting wired devices. The MMBA eliminates the requirement for a plaster ring.

In accordance with one aspect of the invention, there is provided an MMBA that attaches to multiple sizes of standard commercially available junction boxes.

In accordance with another aspect of the invention, there is provided an MMBA that attaches directly to a framing member, for example a wall stud using a Direct Stud Mechanism (DSM).

In accordance with another aspect of the invention, there is provided an MMBA that attaches directly to the framing member and allows the mounting of two junction boxes—one on either side of a wall stud using a Double Direct Stud Mechanism (DDSM).

In accordance with another aspect of the invention, there is provided an MMBA that allows mounting of junction box(es) between two framing members (studs)—using two Between Stud Sliding Mechanisms (BSSMs) and adjustable sliding brackets.

In accordance with another aspect of the invention, there is provided an MMBA that adjusts without any moving parts penetrating the interior of the mating junction box (unlike an adjustable plaster ring).

In accordance with another aspect of the invention, there is provided an MMBA that functions like an adjustable plaster ring but allows shallower, and less expensive junction boxes, to be used because no moving parts penetrate the interior of the junction box.

In accordance with another aspect of the invention, there is provided an MMBA that performs like a new work box (plaster ring not required) but increases the interior volume of the junction box which allows a larger quantity of conductors to be attached and terminated in the junction box.

In accordance with another aspect of the invention, there is provided an improved method of prefabrication using an open back box using an adjustable box mounting plate with an integral or interchangeable new work box, enabling the entire box/bracket assembly, and attached wiring devices, to remain even, or below, the framing member(s) to eliminate common complaints from drywall contractors and to facilitate cleaner installations.

In accordance with another aspect of the invention, the MMBA that performs like a new work box includes an adjustable feature that includes an outer ring and an inner ring wherein a position of the outer ring is fixed and wherein a position of the inner ring may be adjusted outwardly by adjusting one or more screws. This may allow for additional adjustment of the MMBA after a wall substrate and finish materials such as but not limited to drywall, tile, etc. are installed to cover the primary adjusting screws of the MMBA.

### BRIEF DESCRIPTION OF DRAWINGS

The above and other aspects, features and advantages of the present invention will be more apparent from the following more particular description thereof, presented in conjunction with the following drawings wherein:

FIG. 1 is an isometric view of a single box embodiment of a Moveable Mounting Bracket Assembly (MMBA), according to the present invention.

FIG. 2 is an isometric view of a dual box embodiment of the MMBA, according to the present invention.

FIG. 3 is an isometric view of a slider box embodiment of the MMBA, according to the present invention.

FIG. 4 is an isometric view of a Movable Mounting Plate (MMP) of the MMBA, according to the present invention.

FIG. 5A is an isometric view of a Direct Stud Mechanism (DSM) of the MMBA, according to the present invention.

FIG. 5B is an isometric view of a Double Direct Stud Mechanism (DDSM) of the MMBA, according to the present invention.

FIG. 6A is a front view of a Handy Box Extension (HBE) of the MMBA, according to the present invention.

FIG. 6B is a side view of the HBE of the MMBA, according to the present invention.

FIG. 6C is a rear view of the HBE of the MMBA, according to the present invention.

FIG. 7 is an isometric view of a Between Stud Sliding Mechanism (BSSM) of the MMBA, according to the present invention.

FIG. 8 is an isometric view of a Moveable Mounting Plate (MMP) with a single-gang adjustable HBE installed on the face of the MMP, according to the present invention.

FIG. 9 is an isometric view of a Moveable Mounting Plate (MMP) with a double-gang adjustable HBE installed on the face of the MMP, according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

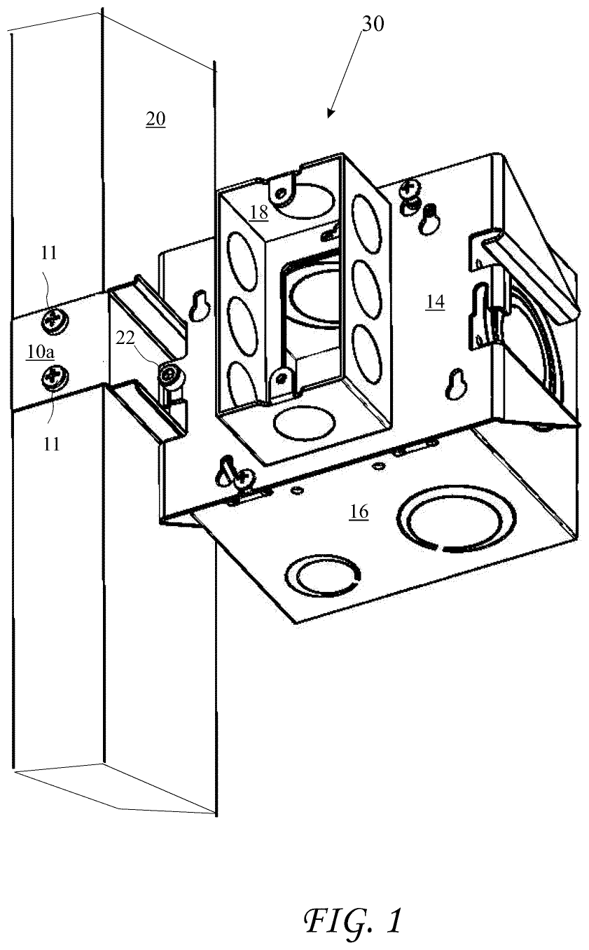

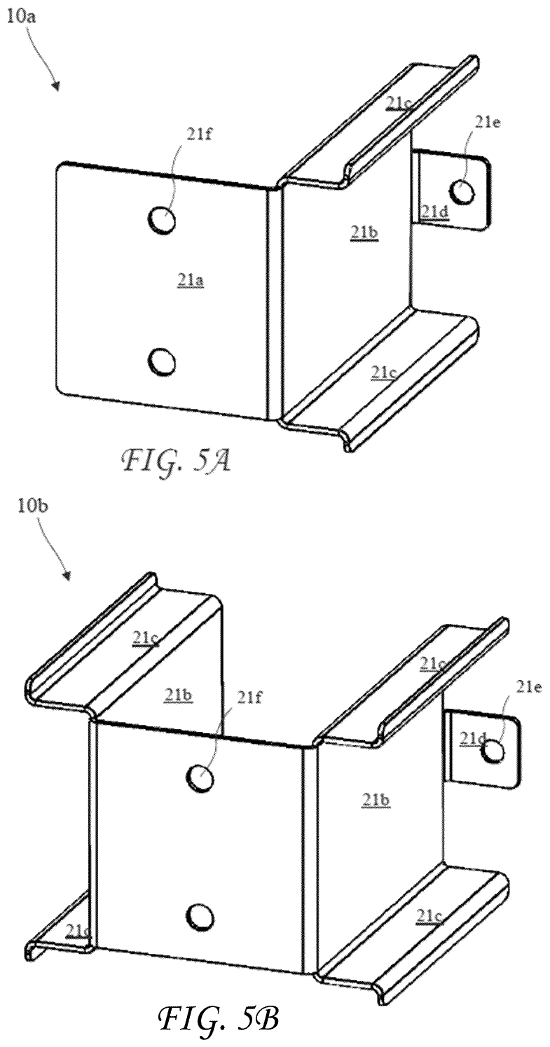

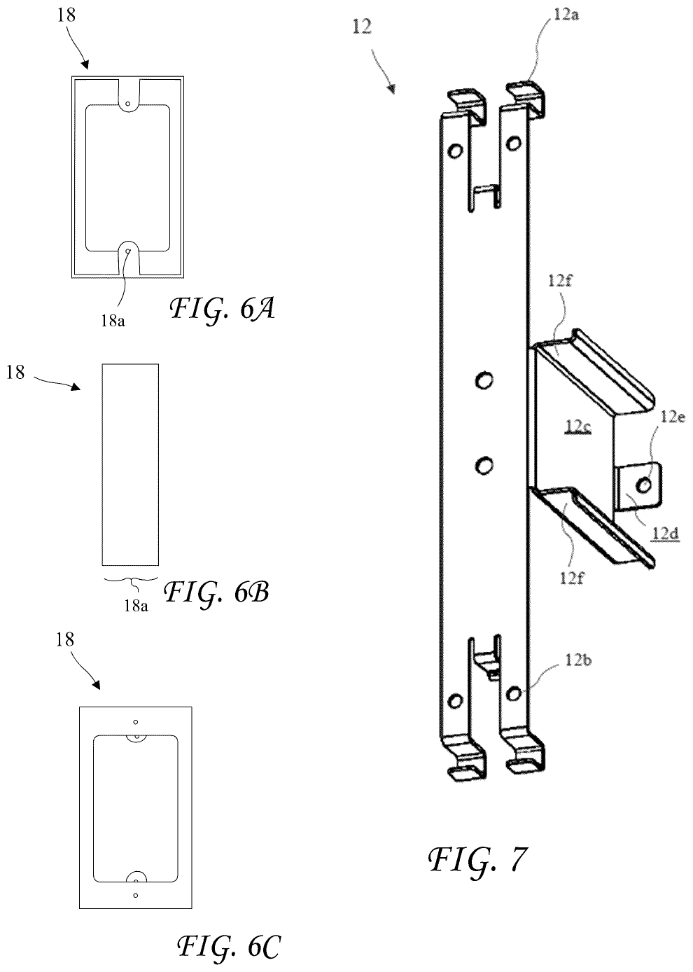

An isometric view of a single box embodiment of a Moveable Mounting Bracket Assembly (MMBA) 30, according to the present invention is shown in FIG. 1. The single box MMBA 30 comprising a Direct Stud Mechanism (DSM) 10a attached to a wall stud 20 by screws 11, a Movable Mounting Plate (MMP) 14 attached to the DSM 10a, a Handy Box Extension (HBE) 18 attached to the face of the MMP 14, and a junction box 16 attached to the back of the MMP 14. The HBE 18 includes a handy box portion 18a and a flange portion 18b (see FIGS. 6A-6C). The DSM 10a having a wall stud flange 21a, an MMP flange 21b, two MMP rails 21c, and an adjusting screw flange 21d (see FIG. 5A). The MMP 14 slides in and out on the MMP rails 21c and is held in position by the depth adjusting screw 22 which threadedly engages the MMP 14.

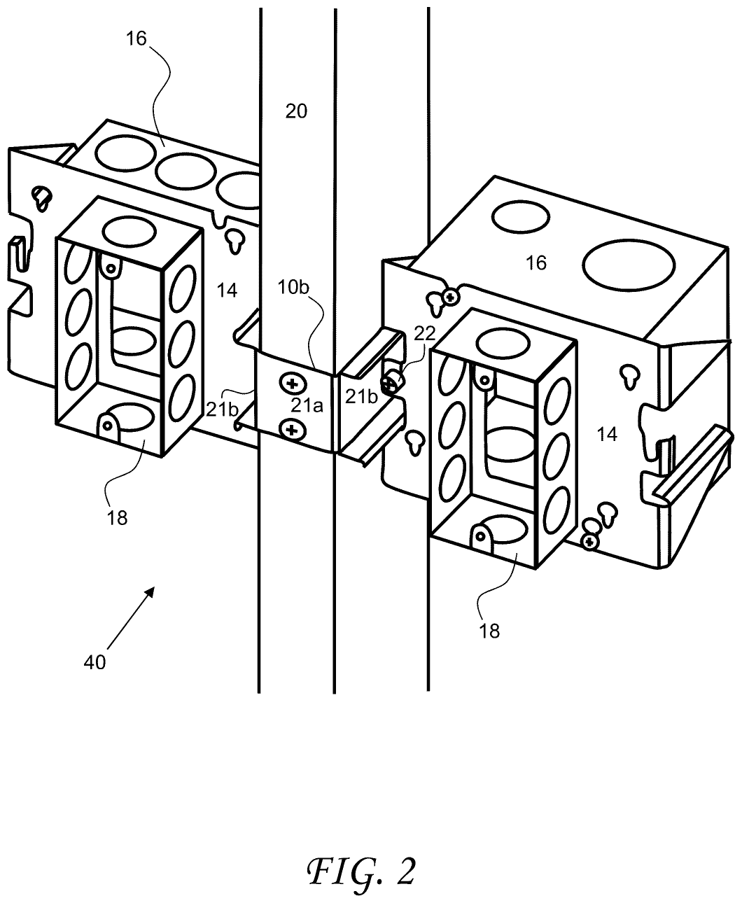

An isometric view of a dual box embodiment of the dual box MMBA 40, according to the present invention, is shown in FIG. 2. The dual box MMBA 40 is similar to the single box MMBA 30, but includes two MMP flange 21b on opposite sides of the wall stud flange 21a (also see FIG. 5B).

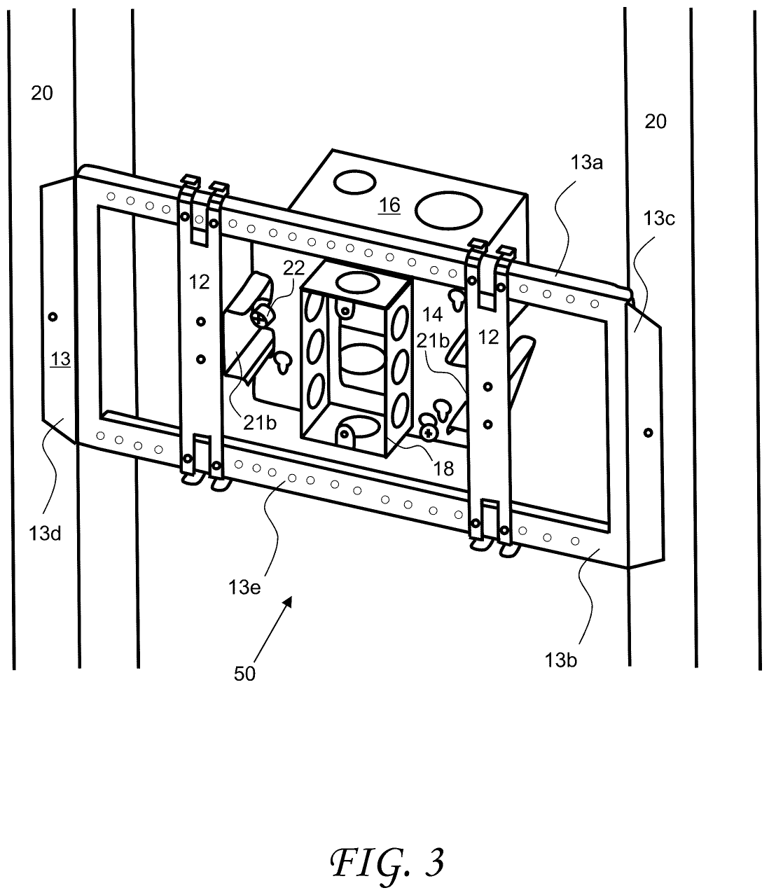

An isometric view of a slider box MMBA 50 is shown in FIG. 3. The slider box MMBA 50 comprising a right and a left Between Stud Sliding Mechanisms (BSSM) 12 (see FIG. 7) attached to a Between Stud Rail Mount (BSRM) 13; the BSRM 13 comprising a top rail 13a, a bottom rail 13b, a right flange 13c, a left flange 13d, and a plurality of holes 13e along the top rail 13a and the bottom rail 13b for screws to fix the position of the BSSMs 12 on the BSRM 13. Each of the BSSMs 12 having a DSM 10a with depth adjusting screw 22 to engage the MMP 14 as depicted on FIG. 3.

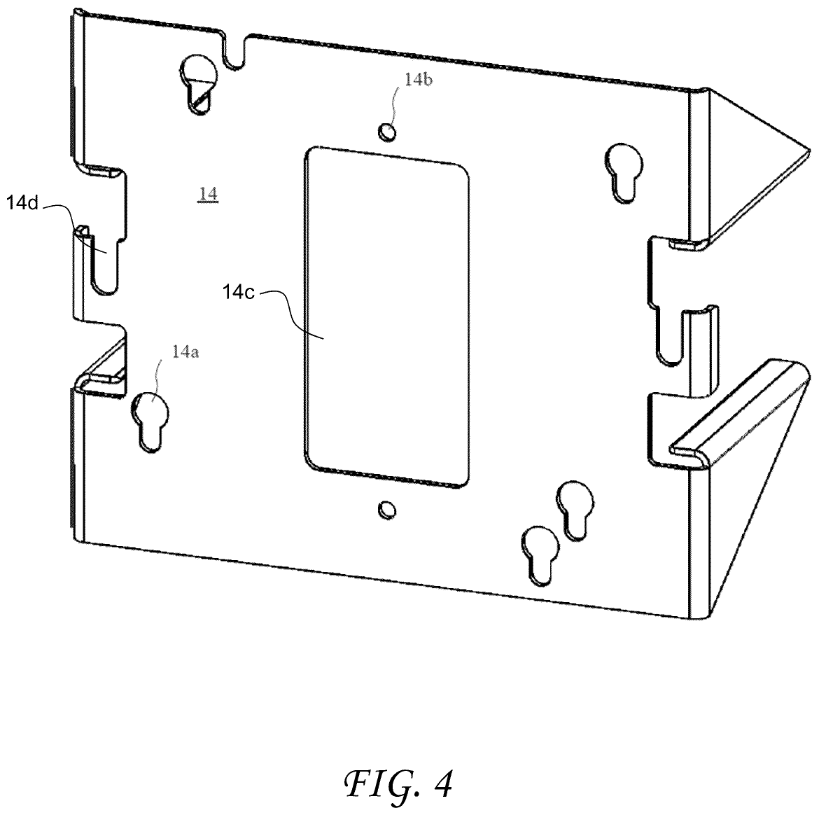

An isometric view of the MMP 14 of the MMBA is shown in FIG. 4. The MMP 14 having mounting holes 14a to attach to standard sized junction boxes, for example either 4″ or 4 11/16″ junction boxes, threaded holes 14b for mounting of the HBE 18 through HBE threaded holes 18a (see FIG. 6A), and a rectangular opening 14c.

An isometric view of a Direct Stud Mechanism (DSM) 10a of the MMBA 30, according to the present invention, is shown in FIG. 5A. The DSM 10a comprising the wall stud flange 21a, an MMP flange 21b, an MMP rails 21c, an adjusting screw flange 21d, a threaded hole 21e to engage the depth adjusting screws 22 (see FIG. 1) and mounting holes 21f to attach fasteners to wall studs 20. The depth adjusting screws 22 engages the MMP 14 and tightening the depth adjusting screws 22 pushes the MMP 14 backwards into a wall and loosening the depth adjusting screws 22 pulls the MMP 14 outward in the wall.

An isometric view of a Double Direct Stud Mechanism (DDSM) 10b of the MMBA, according to the present invention, is shown in FIG. 5B. The DDSM 10b having a wall stud flange 21a, two MMP flanges 21b, two MMP rails 21c for each MMP flange 21b, an adjusting screw flange 21d for each MMP flange 21b, a threaded hole 21e for each adjusting screw flange 21d to engage with the depth adjusting screw(s), and mounting holes 21f to attach fasteners to framing members (studs) 20.

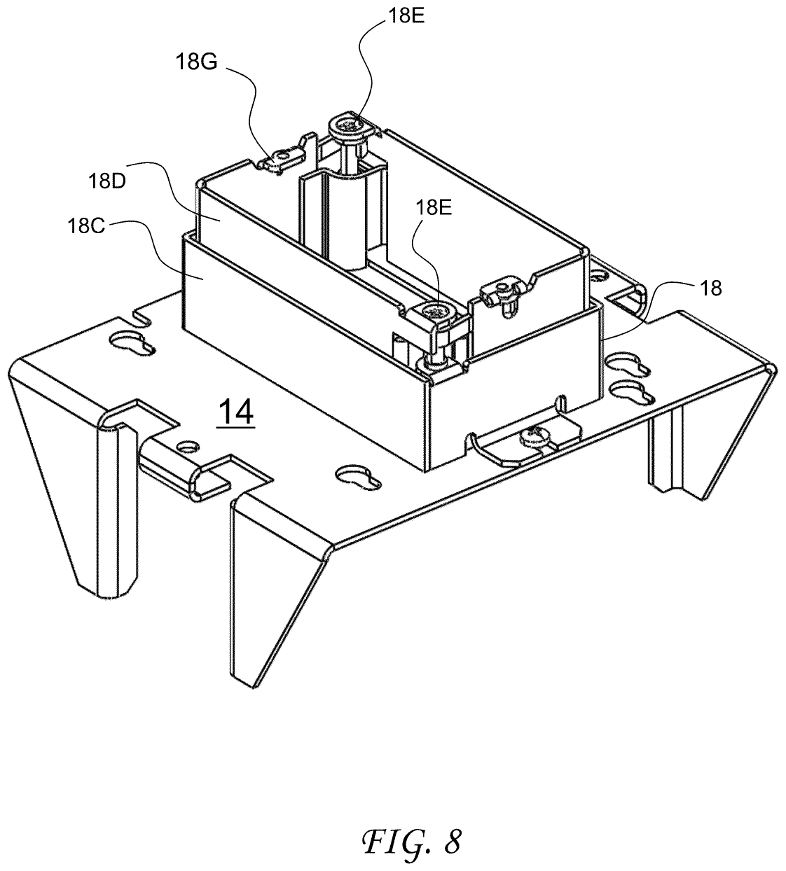

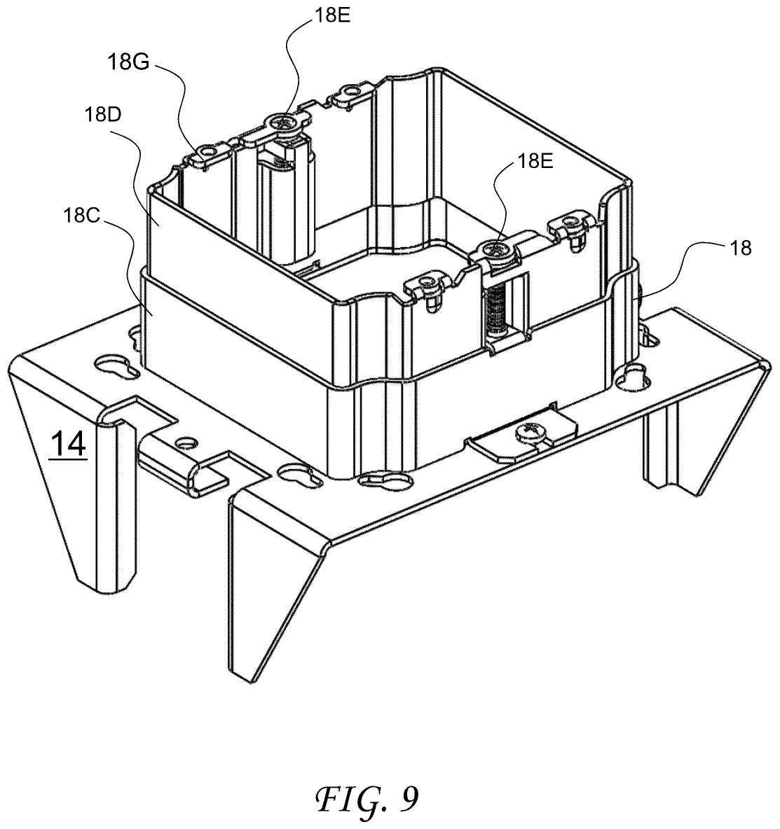

A front view of the HBE 18 of the MMBA, is shown in FIG. 6A, a side view of the HBE 18 is shown in FIG. 6B, and a rear view of the HBE 18 is shown in FIG. 6C. The HBE 18 having two threaded mounting holes 18a in the front, and two threaded holes 18b on the rear (FIG. 6C) to engage the MMP 14. In the embodiment shown in FIG. 6C, these mounting holes 18b are located on the inside of the HBE 18. Alternatively, the mounting holes 18b may be located on the outside of the HBE 18 as shown in FIGS. 8-9.

An isometric view of the BSSM 12 is shown in FIG. 7. A snap flange 12a snaps the BSSM 12 onto the BSRM 13 (see FIG. 3) and holes 12b may accept screws to lock a BSSM 12 position on the BSRM 13 (see FIG. 3). The BSSM 12 having an MMP guide 12c, an adjusting screw flange 12d, a threaded hole 12e to engage with the adjusting screw 22 (see FIG. 3), and MMP rails 12f to guide the motion of the MMP 14.

The invention solves several problems that exist with current product offerings. In one embodiment, for example, utilizing a 4-inch, 4 11/16-inch or multi-gang box, and mounting said gang box on the face of the MMP 14, the MMP 14 has integral features 14d on its sides that assemble to a sliding mechanism: either a DSM 10a, the DDSM 10b or the BSSM 12. On the face of the MMP 14 is a rectangular opening 14c approximately 2″W×3″H (the same size as a new-work box). The MMP rectangular opening 14c may be larger for multi-gang applications.

The HBE 18 may be attached to the MMP rectangular opening 14c, using two screws (See FIG. 8). The HBE 18 may be a standard, commercially available product that is available in varying depths (similar to what is shown in FIGS. 1-3) or a modified version (as shown in FIGS. 8 and 9). The side walls of the HBE 18 form a rectangular flange that penetrates a hole in drywall/substrate. At the top of the flange are two formed downwardly facing ears 18G, with threaded holes facing outward, for the attachment of wiring device(s). By turning a depth adjusting screw(s) 22 on the side(s) of the MMP 14, the HBE flange will move out (or in) so the installer can bring the front edge of the flange flush with the face of the finished wall (to meet the requirements of the NEC). Handy box extensions are commercially available in various depths and may be selected based on the thickness of the drywall and finished wall substrate. For very thick substrates, multiple HBEs 18 may be stacked.

This same concept described above for single gang (one wiring device) applications may be employed for 2-gang (2 wiring devices)—See FIG. 9, and multi-gang (3+-gangs) applications. Other, non-commercially (custom) available HBEs may be fabricated to achieve various applications as needed.

In some embodiments, a modified HBE 18 as shown in FIGS. 8-9 that comprises an outer ring 18C and an inner ring 18D that may be adjusted outwardly from the face of the MMP 14 by turning one or more screws 18E. This will allow additional adjustment of the wiring device after the wall substrate is applied to the studs (adjustment of the MMP 14 may not be performed when wall substrate has been applied to the studs because the adjusting screws 22 are blocked by the substrate).

In some embodiments, the HBE 18 maybe attached to the MMP 14 with screws or the HBE 18 maybe an integral aspect of the MMP 14, a unitary component stamped or otherwise fabricated or permanently assembled by welding or other attachment means.

A version of the MMP 14 may also be offered to allow the attachment of a so-called “extension box”. These are commercially available for virtually all junction box sizes. Often systems and equipment are mounted directly to junction box screws and the MMP/sliding mechanism would allow said extension box to move in and out of the stud cavity. The inventor envisions that the MMP 14 can be designed so one MMP 14 can mount either a 4″ or a 4 11/16″ junction box. Multiple hole patterns will be included so attachment to either box can be achieved. Other versions of the MMP 14 for attaching to multi-gang boxes will be available for different junction box sizes, e.g., a 2-Gang mounting plate can be attached to both a 2-gang and a 3-gang junction box.

The adaptation of the HBE 18 to the MMP 14 greatly improves the functionality and intended use of the new-work box design by vastly increasing the volume in the box and as a result the quantity of wires that may enter, and be terminated in, the box.

To improve efficiency (reduce assembly time), the MMP 14 may be fabricated with an integral handy box (rectangular flange) stamped, drawn, welded, or otherwise permanently fastened to the front face of the MMP 14. The depth of the rectangular flange will be equal to the maximum travel of the side adjusting mechanism. If, for example, the maximum travel length of the sliding adjusting mechanism is 1.5″ then when the adjusting screw is in its “shipped” position then the face of the rectangular flange will be even with the front of the framing members (studs). When the adjusting screw is turned all the way out, then the rectangular flange will penetrate a hole made in drywall/substrate that is up to 1.5″ thick. The mechanism will move the junction box 16 in and out of the wall and with it the mounting plate/rectangular flange component.

For applications where the drywall/substrate thickness is thicker than 1.5″, an additional HBE 18 can be added on top of the first one to ensure that the face of the rectangular flange will be flush with the face of the finished wall. Alternatively, an adjustable type HBE may be employed (FIG. 8 & FIG. 9).

### Different Mounting Applications Explained

Uses of the three primary mounting brackets, the DSM 10a, the DDSM 10b, and the BSRM 13, are further described below with reference to the figures:

The DSM 10a is assembled to the MMP 14 using the adjusting screw 22 to form the MMBA 30 (see FIG. 1). When the adjusting screw 22 is tightened, the head of the adjusting screw 22 applies force to the face of the MMP 14 pushing it into the stud cavity. When the adjusting screw 22 is loosened the screw thread exerts force in the opposite direction to pull the MMP 14 forward out of the stud cavity. Using a left-handed threaded screw will achieve opposite results.

For typical applications, only one DSM 10a will be attached to a stud 20. Hence, if the installer desires to install the MMBA 30 assembly on a stud 20 to the left, then the DSM 10a will engage the MMP 14 on the left; If the installer desires to install the MMBA 30 assembly on a stud 20 to the right, the then DSM 10a will engage the MMP 14 on the right. The location of the DSM 10a may be set at a factory, prefabrication facility or changed by the installer. If so desired, two DSMs 10a may be attached to the MMP 14. This application may be advantageous when studs 20 are mounted narrowly and support is required on both sides of the MMP.

The DDSM 10b is assembled to the MMP 14 using the adjusting screw 22 to form the MMBA 40 (see FIG. 2). The DDSM 10b operates identically to the DSM 10a, except that the DDSM 10b allows two MMPs 14 to be mounted adjacent to one another. This application is provided for when the installer has a requirement to install one MMP 14 on the left of a stud 20, and another MMP 14 on the right side of the same stud 20. Though mounted together, the two assemblies may be configured differently, e.g., different sized junction boxes, different quantity of wiring devices, etc. and the two assemblies of components operate independent of each other.

The BSSM 12 is assembled to the MMP 14 using the adjusting screw 22 to form the slider box embodiment of the MMBA 50 (see FIG. 3). For applications where a junction box needs to be positioned between two studs 20, as opposed to directly to a stud 20, the MMP 14 is to be used with two BSSMs 12. Two BSSMs 12 engage on opposite sides of the MMP 14 using screws. The assembly process and functionality are identical to that of the DSM 10a and the DDSM 10b. Future embodiments of the BSSM may be that only one component is needed, that is, that the function of two BSSMs may be combined into a single apparatus to speed assembly of the components.

After the BSSMs 12 are attached to the MMP assembly they are “snapped” onto the BSMR 13. This bracket opens, and closes, from an approximate minimum of 13″ to a maximum of 23″ so it may be secured, using standard fasteners, to two adjacent studs 20. The rails of the bracket may be cut to shorten them if the space between studs is less than 13″.

The installer may, if desired, install a fastener through one or more holes in the BSSM 12 and into a mating hole in the sliding bracket rail(s). Performing this step will “lock” in the lateral (left to right) position of the junction box assembly.

### Application Using an Open Back Box

Embodiments of the present invention that comprise an open back box are further described below with reference to the figures:

A method for prefabrication using an open back box is disclosed in U.S. Pat. No. 8,168,887 (the '887 patent). The '887 patent and related patents require the use of a “plaster ring.” A plaster ring attaches to the face of a junction box and is available in various standard commercial sizes. Plaster rings are configured to facilitate attachment of one or more wiring devices to its face.

Plaster rings are designed to be used with varying thicknesses of applied (to framing members) drywall/substrate, from 0 inches to 2+ inches. The “depth” of a plaster ring corresponds to the thickness of a finished wall's drywall/substrate. For instance, if one layer of ⅝″ drywall is applied to a framed wall, then a ⅝″ plaster ring will be used. The industry also offers an “adjustable” plaster ring that typically has a range, e.g., from ⅝″ to 1½″. Adjustable rings allow for more flexibility and can be used for various drywall/substrate thicknesses and/or to make minor adjustments to the plaster ring depth to ensure the front edge of the plaster ring finishes flush (within ⅛″) with the face of a finished wall—a Code requirement. Adjustable plaster rings are also used to reduce inventory requirements, e.g., one size fits all.

An open back box, without a plaster ring being attached, may be mounted directly to a framing member by fastening the box to the framing member, using screws inserted through holes in the side walls of the box and then fastening them to the framing members. A junction box, open back or traditional closed-back type, cannot be fastened to a framing member through junction box side-mounted holes if the plaster ring is attached to the face of the junction box because access to the side mounting holes (on the inside of the junction box) become inaccessible with the plaster ring attached to the face of the junction box.

A mounting bracket that is designed for the purpose must be employed to fasten a junction box/plaster ring assembly to a framed member, or in applications where the installer is required to position the junction box between, instead of directly on, two adjacent framing members. Therefore, to facilitate the installation of an “Open Back Junction Box and Method for Pre-fab Wiring” both a mounting bracket and a plaster ring are required.

The present invention improves the efficiency of the open back junction box and method for pre-fab wiring as detailed in the '887 patent by eliminating the requirement for a plaster ring. The MMP 14 facilitates the installation of wiring device(s) without a plaster ring. Moreover, as previously detailed, above, there is no need for different sizes (depths) of plaster rings because the mounting flange where the wiring device(s) mounts may move in and out of the drywall/substrate in response to the installer's turning of an adjusting screw(s).

The mechanism of the assemblies 30, 40, or 50 (FIGS. 1, 2, and 3) achieves the same function as an adjustable plaster ring. However, the assemblies 30, 40, or 50 mechanically operate much differently than an adjustable plaster ring. The assemblies 30, 40, or 50 move the entire junction box in and out of the wall whereas with an adjustable plaster ring the junction box remains stationary and the inner sleeve of the adjustable plaster ring expands/contracts in response to the installer turning multiple adjusting screws.

As previously explained, an adjustable plaster ring has an inherent flaw in that when the inner sleeve is retracted it protrudes into the junction box. The inwardly protruding sleeve reduces interior space in the junction box, blocks the sidewall knock-out holes that fittings are designed to be connected to and can even damage the internal wires in the junction box. All these problems with the adjustable plaster ring are eliminated with the use of the assemblies 30, 40, or 50 as there are no moving sleeves or parts that protrude into the junction box to which it is mounted. Moreover, an adjustable plaster ring may not be used with 1.5″ or 1.25″ deep junction boxes due to the internal interference problems explained above. These junction boxes may be used, utilizing full box fill availability, without interference, or threat of damaging internal wires, when employing the assemblies 30, 40, or 50.

Lastly, a common complaint with the open back junction box and method for pre-fab wiring, with a plaster ring installed, is that the plaster ring extends out in front of the framing members before drywall or other substrate is applied to the framing members. This issue, and related problems, are amplified if the wiring device(s) are pre-installed in the plaster ring which they typically are with the open back junction box and method for pre-fab wiring. Drywall contractors have complained about wiring devices being pre-installed since prefabrication became prevalent in the commercial construction industry and these complaints continue to this day. Drywall contractors complain that “taping” and other finish work related to installation of drywall takes considerably longer (and is more costly) when the wiring devices are pre-installed and often seek additional compensation. There is no way to avoid this issue when using a plaster ring and pre-installed wiring device in the open back junction box and method for pre-fab wiring because the plaster ring and the device(s) attached to it cannot be retracted below the same plane as the face of the framing member (stud 20).

The use of the assemblies 30, 40, or 50 eliminates the above-described problem because the junction box may be adjusted to sit back behind the framing members 20—with the front face of the wiring device mounting flange, and pre-installed wiring device, flush with the face of the framing member 20 (sitting just behind the drywall).

After drywall/substrate is installed, and after the drywall installer cuts a hole in the drywall for the MMP flange, then the installer can adjust the operating screw of the assemblies 30, 40, or 50, turning the screw continuously until the front edge of the HBE 18 is flush with the face of the drywall/substrate (or further if additional material is to be installed on top of the drywall/substrate, e.g. tile. Some may object to this process by saying that the adjusting screw 22 will be covered with drywall. While this is true, in this application of the invention, it is envisioned that a “template” be provided the installer that can be aligned with the opening in the drywall wall that includes a “drill location.” The installer can insert a metal driving bit, driven by a battery-operated drill, through the guide hole in the template, to engage with the screw head of the adjusting screw 22. The hole created by the driving bit will be filled/patched during the normal taping operation performed by the drywall contractor.

While the invention herein disclosed has been described by means of specific embodiments and applications thereof, numerous modifications and variations could be made thereto by those skilled in the art without departing from the scope of the invention set forth in the claims.

1. A moveable mounting bracket assembly (MMBA) comprising:
a direct stud mechanism (DSM) that attaches to a framing member;
a moveable mounting plate (MMP) having mounting holes;
a Handy Box Extension (HBE) connected to the MMP; and
an adjusting screw connecting the MMP to the DSM providing adjustment of the depth of the MMP.

2. The MMBA of claim 1, wherein the DSM having:
a wall stud flange having a plurality of screw holes;
a MMP flange connected to the wall stud flange;
a MMP top rail connected to the MMP flange;
a MMP bottom rail connected to the MMP flange; and
an adjusting screw flange to receive the adjusting screw.

3. The MMBA of claim 1, wherein the DSM is a double DSM having:
a wall stud flange having a plurality of screw holes;
a right MMP flange connected to the wall stud flange on the right side;
a MMP top rail connected to the right MMP flange;
a MMP bottom rail connected to the right MMP flange;
an adjusting screw flange reaching from the right MMP flange to receive the adjusting screw;
a left MMP flange connected to the wall stud flange on the left side;
a MMP top rail connected to the left MMP flange;
a MMP bottom rail connected to the left MMP flange; and
an adjusting screw flange reaching from the left MMP flange to receive the adjusting screw.

4. The MMBA of claim 1, wherein the MMP further having:
mounting holes to attach junction boxes;
threaded holes for the mounting of the HBE;
an opening; and
a slide chamber to receive the adjusting screw.

5. The MMBA of claim 4, wherein the HBE is attached to the MMP with screws.

6. The MMBA of claim 4, wherein the HBE is an integral aspect of the MMP.

7. The MMBA of claim 1, wherein the HBE is a modified version comprising:
an outer ring;
an inner ring movably resting within the outer ring;
one or more adjusting screws, wherein the inner ring maybe adjusted outwardly or inwardly from the face of the MMP by turning the one or more adjusting screws.

8. The MMBA of claim 1, wherein the HBE maybe a single gang configuration, a two gang configuration, or a multi-gang configuration.

9. A moveable mounting bracket assembly (MMBA) comprising:
a between stud rail mount (BSRM) attachable to two or more framing members;
a plurality of between stud sliding mechanism (BSSM) connected to the BSRM;
a moveable mounting plate (MMP) having mounting holes;
a Handy Box Extension (HBE) connected to the MMP; and
adjusting screws engages the MMP on the left and right side of the MMP and is connected to the BSSM providing adjustment of the depth of the MMP.

10. The MMBA of claim 9, wherein there are two BSSM connected to the BSRM.

11. The MMBA of claim 9, wherein the BSSM further having:
a top snap flange and a bottom snap flange that attachably engages the BSRM;
a plurality of holes for securing the BSSM to the BSRM;
a MMP guide;
an adjusting screw flange;
a threaded hole to engage with the adjusting screw; and
MMP rails.

12. The MMBA of claim 9, wherein the BSRM having:
a rectangular frame having a top rail, a bottom rail, a left jamb, and a right jamb;
the bottom rail and the top rail having a plurality of equally distant holes that corresponds to holes on the BSSM for securing the BSSM to the BSRM; and
the left and right jambs having flanges to secure the BSRM to at least two framing members.

13. The MMBA of claim 9, wherein the MMP further having:
mounting holes to attach junction boxes;
threaded holes for the mounting of the HBE;
an opening; and
a slide chamber to receive the adjusting screw.

14. The MMBA of claim 13, wherein the HBE may be attached to the rectangular opening using screws.

15. The MMBA of claim 9, wherein the HBE maybe a modified version comprising:
an outer ring;
an inner ring movably resting within the outer ring;
one or more adjusting screws, wherein the inner ring maybe adjusted outwardly or inwardly from the face of the MMP by turning the one or more adjusting screws.

16. MMBA of claim 9, wherein the HBE maybe a single gang configuration, a two gang configuration, or a multi-gang configuration.
